(19) United States
(12) Patent Application Publication
(10) Pub. No.: US 2013/0065809 A1
(43) Pub. Date: Mar. 14, 2013

(54) STRIPPING COMPOSITIONS AND METHODS OF MAKING AND USING THE SAME

(71) Applicants: Carmine Savaglio, Kenosha, WI (US); Nathan E. Ludtke, Waterford, WI (US)

(72) Inventors: Carmine Savaglio, Kenosha, WI (US); Nathan E. Ludtke, Waterford, WI (US)

(73) Assignee: DIVERSEY, INC., Sturtevant, WI (US)

(21) Appl. No.: 13/698,932

(22) PCT Filed: May 20, 2011
(86) PCT No.: PCT/US11/37333

§ 371 Date: Nov. 19, 2012

Related U.S. Application Data
(60) Provisional application No. 61/346,726, filed on May 20, 2010.

(51) Int. Cl. C11D 3/60

(52) U.S. Cl. 510/212

(57) ABSTRACT

Provided are compositions suitable for stripping coatings from a surface. The compositions may include a solvent and an organic functional amine. The solvent may be benzyl alcohol. The compositions may further include at least one surfactant. The compositions may include at least two surfactants present in the composition at a ratio of about 1:1 to each other. Also provided are methods of stripping a coating from a surface, the method including applying to the surface a composition according to the invention.

### CROSS-REFERENCE TO RELATED APPLICATIONS

This application claims the benefit of priority to U.S. Provisional Patent Application No. 61/346,726 filed May 20, 2010, which is incorporated herein by reference in its entirety.

### FIELD OF INVENTION

The present invention relates to concentrated compositions for stripping a coating from a surface.

### BACKGROUND

Coatings are often used to protect various surfaces from wear, staining, moisture, etching, etc. The coatings may be removed for subsequent reapplication or other maintenance of the surface. Various compositions are available for stripping coatings from surfaces. Conventional stripping compositions may be expensive and difficult to use, include harsh chemicals, or function poorly at dilute concentrations. Conventional concentrated stripping compositions may include a high concentration of active agents to be diluted to suitable working concentrations at use, thus reducing cost and eliminating the need for transport of larger volumes. However, the high concentration of active agents in conventional concentrated stripping compositions often requires the use of co-solvents to solubilize the active agents. Conventional concentrated stripping compositions may also have high surface tension, causing them to sheet poorly on a surface. Concentrated stripping compositions with stable active components are desired that have good wetting properties, i.e. they are liquids that maintain contact with a solid surface.

### SUMMARY

In one embodiment, the invention may provide a composition suitable for stripping coatings from a surface. The composition may include a solvent and an organic functional amine. The composition may comprise solvent and organic functional amine together in an amount of at least about 75% by weight of the composition. The solvent may comprise benzyl alcohol. The composition may further comprise at least two surfactants.

In another embodiment, the invention may provide a composition suitable for stripping coatings from a surface. The composition may include about 25% to about 50% by weight of benzyl alcohol, about 25% to about 50% by weight of an organic functional amine, and substantially no fatty acid. The composition may further comprise at least one surfactant.

In another embodiment, the invention may provide a composition suitable for stripping coatings from a surface. The composition may include benzyl alcohol, an organic functional amine, and at least two surfactants. The surfactants may be present in a ratio of about 1:6 to about 6:1 to each other.

In another embodiment, the invention may provide a method of stripping a coating from a surface. The method may include applying at least one of the compositions described above to the coating.

Other aspects of the invention will become apparent by consideration of the detailed description and accompanying drawings.

### BRIEF DESCRIPTION OF THE DRAWINGS

FIG. 1 is a graph depicting the number of cycles needed to remove 10 coats of SIGNATURE™ (Diversey, Inc., Sturtevant, Wis.) floor finish using various stripping compositions.

FIG. 2 is a graph of the number of cycles needed to remove 10 coats of VECTRA™ (Diversey, Inc., Sturtevant, Wis.) floor finish using various stripping compositions.

FIG. 3 is a graph of the number of cycles needed to remove 10 coats of PREMIA™ (Diversey, Inc., Sturtevant, Wis.) floor finish using various stripping compositions.

FIG. 4 is a graph of the initial foam height for dilutions of various stripping compositions.

FIG. 5 is a graph of the foam height after 5 min for dilutions of various stripping compositions.

### DETAILED DESCRIPTION

Before any embodiments of the invention are explained in detail, it is to be understood that the invention is not limited in its application to the details of construction and the arrangement of components set forth in the following description. The invention is capable of other embodiments and of being practiced or of being carried out in various ways.

In one embodiment, the invention provides a composition for stripping a coating from a surface. The stripping compositions may comprise a solvent and an organic functional amine. The solvent may comprise at least one of an alcohol, an ester, a phthalate-based solvent, a pyrrolidone-based solvent, and combinations thereof.

Examples of alcohols may include, but are not limited to, polyhydric alcohols where the alcohol is an alkane polyol having 2 to 6 carbons and 2 to 3 hydroxyls in the molecule. Examples of polyhydric alcohols may include, but are not limited to, an ethylene glycol; propylene glycol, dipropylene glycol, glycerin, 1,2-butandediol, 1,3-butanediol, 1,4-butanediol, 1,4-butanediol, 2,3-butanediol, 1,2-propanediol, 1,5-pentanedial, meso-erythritol, neopentyl glycol, pentaerythritol, and combinations and blends thereof. Aromatic alcohol derivatives may also be useful. Examples of alcohols include, but are not limited to, a benzyl alcohol, xylenol, phenol, etc. Solvents may also include, but are not limited to, glycol ether based solvents based on ethylene or propylene glycol, diethylene glycol ethyl ether, dipropylene glycol methyl ether, diethylene glycol butyl ether, ethylene/diethylene glycol 2-ethylhexyl ether, ethylene glycol phenyl ether, dipropylene glycol propyl ether, dipropylene glycol butyl ether, propylene glycol phenyl ether, and blends thereof. Additionally, mono-alcohols such as methanol, ethanol, propanol, isopropanol, and butanol can be utilized in the solvent system. In certain embodiments, the solvent comprises benzyl alcohol.

Examples of esters in the solvent may include, but are not limited to, glycol ether dibenzoates based on ethylene or propylene glycol including, but not limited, to propylene glycol dibenzoate, dipropylene glycol dibenzoate, polypropylene glycol diobenzoate, ethylene glycol dibenzoate, diethylene glycol dibenzoate, polyethylene glycol dibenzoate, neopentyl glycol dibenzoate, and the like as well as isodecyl benzoate, dipropylene glycol monomethyl ether benzoate, 2,2,4-trimethyl-1,3-pentanediol diisobutyrate and combinations thereof.

Examples of phthalate-based solvents in the solvent may include, but are not limited to, dibutyl phthalate, butyl benzyl phthalate, diethyl phthalate, and combinations thereof may also be used. Pyrollidone-based solvents may include, but are not limited to, 2-pyrollidone, N-methylpyrrolidone, N-octyl-2 pyrrolidone, and combinations thereof. Terpene derivatives are also suitable for use in the solvent system. Examples of terpenes include, but are not limited to, cyclic terpenes such as D-limonene, pinene, etc. The solvent system may optionally include water.

Organic functional amines generally include at least an organic group and an amine. Examples may include, but are not limited to, monoethanolamine (MEA), diethanolamine (DEA), triethanolamine (TEA), monoisopropanolamine, n-alkyl substituted derivatives thereof, or combinations thereof. The functional amine may be monoethanolamine.

The compositions may further comprise at least one surfactant. Surfactants may include, but are not limited to, at least one of anionic surfactants, nonionic surfactants, amphoteric surfactants, and combinations thereof. Amphoteric surfactants may include, but are not limited to, amine oxides such as C₈-C₂₀ amine oxides, betaines such as alkylamidopropylbetaine, sultaine, and alkylamino propionates.

Anionic surfactants may be water-soluble salts, particularly, alkali metal salts of organic sulfur reaction products having in their molecular structure an alkyl radical containing from about 8 to about 22 carbon atoms and a radical selected from the group consisting of sulfamic acid and sulfuric acid ester radicals. Such surfactants are well known in the art and are described at length in “Surface Active Agents and Detergents”, Vol. II by Schwartz, Perry and Berch, Interscience Publishers Inc., 1958, incorporated by reference herein. Examples of anionic surfactants include, but are not limited to, amides, sulfosuccinates and derivatives, sulfates of ethoxylated alcohols, sulfates of alcohols, sulfonates and sulfonic acid derivatives, phosphate esters, and polymeric surfactants. Examples of anionic surfactants may include, but are not limited to, alkyl sulfate, ether sulfate, alkyl sulfonate, alkyl benzene sulfonate, alpha olefin sulfonate, diphenyloxide disulfonate, alkyl naphthalene sulfonate, sulfosuccinate, sulfosuccinamate, naphthalene-formaldehyde condensate, isethionate, N-methyl taurate, phosphate ester, and ether carboxylate. Examples of anionic surfactants include alkyl diphenyloxide disulfonates. Other examples of anionic surfactants may include, but are not limited to, DOWFAX™ 2A1, DOWFAX™ 3B2, and DOWFAX™ C10L (alkyldiphenyloxide disulfonates from Dow, Midland, Mich.); CALSOFT® AOS-40 sodium alpha olefin sulfonate and CALSOFT® LAS-99 linear alkylbenzene sulfonic acid (Pilot Chemical, Cincinnati, Ohio); and STEOL® CA-460 alkyl ether sulfate ammonium salt and STEOL® CS-460 sodium laureth sulfate (Stepan Company, Northfield, Ill.).

Nonionic surfactants may include, but are not limited to, compounds produced by the condensation of alkylene oxide groups (hydrophilic in nature) with an organic hydrophobic compound, which may be aliphatic or alkyl aromatic in nature. The length of the hydrophilic or polyoxy alkylene radical which is condensed with any particular hydrophobic group can be readily adjusted to yield a water-soluble compound having the desired degree of balance between hydrophilic and hydrophobic elements. Examples of nonionic surfactants include, but are not limited to, alkanolamides, amine oxides, block polymers, ethoxylated primary and secondary alcohols, ethoxylated alkylphenols, ethoxylated fatty esters, sorbitan derivatives, glycerol esters, propoxylated and ethoxylated fatty acids, alcohols, and alkyl phenols, glycol esters, polymeric polysaccharides, sulfates and sulfonates of ethoxylated alkylphenols, and polymeric surfactants.

Nonionic surfactants are conventionally produced by condensing ethylene oxide with a hydrocarbon having a reactive hydrogen atom, e.g., a hydroxyl, carboxyl, amino, or amido group, in the presence of an acidic or basic catalyst. Nonionic surfactants may have the general formula RA(CH₂CH₂O)ₙH wherein R represents the hydrophobic moiety, A represents the group carrying the reactive hydrogen atom, and n represents the average number of ethylene oxide moieties. R may be a primary or a secondary, straight or slightly branched, aliphatic alcohol having from about 8 to about 24 carbon atoms. Additional examples of nonionic surfactants can be found in U.S. Pat. No. 4,111,855, Barrat, et al., issued Sep. 5, 1978, and U.S. Pat. No. 4,865,773, Kim et al., issued Sep. 12, 1989, which are hereby fully incorporated by reference.

Other nonionic surfactants useful in the composition include ethoxylated alcohols or ethoxylated alkyl phenols of the formula R(OC₂H₄)ₙOH, wherein R is an aliphatic hydrocarbon radical containing from about 8 to about 18 carbon atoms or an alkyl phenyl radical in which the alkyl group contains from about 8 to about 15 carbon atoms, and n is from about 2 to about 14. Examples of such surfactants are listed in U.S. Pat. No. 3,717,630, Booth, issued Feb. 20, 1973, U.S. Pat. No. 3,332,880, Kessler et al., issued Jul. 25, 1967, and U.S. Pat. No. 4,284,435, Fox, issued Aug. 18, 1981, which are hereby fully incorporated by reference.

Moreover, other nonionic surfactants include the condensation products of alkyl phenols having an alkyl group containing from about 8 to about 15 carbon atoms in either a straight chain or branched chain configuration with ethylene oxide, said ethylene oxide being present in an amount from about 2 to about 14 moles of ethylene oxide per mole of alkyl phenol. The alkyl substituent in such compounds can be derived, for example, from polymerized propylene, diisobutylene, and the like. Examples of compounds of this type include nonyl phenol condensed with about 9 moles of ethylene oxide per mole of nonyl phenol, dodecyl phenol condensed with about 8 moles of ethylene oxide per mole of phenol, and the commercially available T-DET® 9.5 marketed by Harcros Chemicals Incorporated.

Other useful nonionic surfactants are the condensation products of aliphatic alcohols with from about 2 to about 14 moles of ethylene oxide. The alkyl chain of the aliphatic alcohol can either be straight or branched, primary or secondary, and may contain from about 8 to about 18 carbon atoms. Examples of such ethoxylated alcohols include secondary alcohol nonionic surfactants such as ENS-70, the condensation product of myristyl alcohol condensed with about 9 moles of ethylene oxide per mole of alcohol, and the condensation product of about 7 moles of ethylene oxide with coconut alcohol (a mixture of fatty alcohols with alkyl chains varying in length from 10 to 14 carbon atoms). Examples of commercially available nonionic surfactants in this type include: NEODOL™ 45-9, NEODOL™ 23-6.5, NEODOL™ 45-7, NEODOL™ 91-6, and NEODOL™ 45-4 marketed by Shell Chemical Company (Houston, Tex.); Kyro EOB marketed by The Procter & Gamble Company (Cincinnati, Ohio); and BEROL® 260 and BEROL® 266 marketed by Akzo Nobel (alcohol ethoxylates from Amsterdam, Netherlands). Other suitable nonionic surfactants include NEODOL™ ethoxylates, commercially available from Shell Chemical Company (Houston, Tex.) and TERGITOL™ surfactants such as TERGITOL™ 15-S-7 or 15-S-9 available from Dow (Midland, Mich.). Additional nonionic surfactants may be selected from the class of fluorinated materials, such ZONYL® FSJ, ZONYL® FSN, etc., commercially available from DuPont (Wilmington, Del.). Suitable nonionic surfactants may include primary and secondary alcohol ethoxylates and alkyl polyglucosides. Primary alcohol ethoxylates may include C9-C11 primary alcohol ethoxylates such as TOMADOL® 91-2.5, TOMADOL® 91-6, and TOMADOL® 91-8 from Air Products and Chemicals (Allentown, Pa.). Secondary alcohol ethoxylates may include C12-C14 secondary alcohol ethoxylates such as TERGITOL® 15-S-3, TERGITOL® 15-S-7, and TERGITOL® 15-S-9. TERGITOL® is a trademark of Union Carbide Corporation (Houston, Tex.) for C8-C18 non-ionic surfactants with 1-15 moles of ethylene oxide. Alkyl polyglucosides may include C8-C16 alkyl polyglucosides such as GLUCOPON® 625FE and GLUCOPON® 425N from Henkel Corporation (Dusseldorf, Germany), and TRITON™ BG-10 (Dow, Midland, Mich.). A mixture of nonionic surfactants may also be used. Examples of specific nonionic surfactants further include but are not limited to CALOXAMINE® LO lauryl dimethylamine oxide (Pilot Chemical, Cincinnati, Ohio).

The composition may comprise at least one surfactant, and in some embodiments at least two surfactants. The at least two surfactants may be present in the composition at a ratio of about 6:1 to about 1:6, about 5:1 to about 1:5, about 4:1 to about 1:4, about 3:1 to about 1:3, about 2:1 to about 1:2, about 1:1.5 to about 1.5:1, about 1.25:1 to about 1:1.25, or about 1:1 with each other. The surfactants may be combined in a ratio of about 1:1 with each other in the composition. In certain embodiments, the at least two surfactants may be an anionic surfactant and a nonionic surfactant. For example, the at least two surfactants may be chosen from alkyl diphenyloxide disulfonates, secondary alcohol ethoxylates, primary alcohol ethoxylates, and alkyl polyglucosides.

In certain embodiments, the solvent of the compositions may comprise benzyl alcohol. In certain embodiments, the compositions may comprise benzyl alcohol and an organic functional amine. In certain embodiments, the compositions may comprise benzyl alcohol, an organic functional amine, and at least two surfactants.

The stripping composition may comprise benzyl alcohol in an amount of at least about 25%, at least about 30%, or at least about 40% by weight of the composition. The stripping composition may comprise benzyl alcohol in an amount less than about 60%, or less than about 50% by weight of the composition. The stripping composition may comprise organic functional amine in an amount of at least about 25%, at least about 30%, or at least about 40% by weight of the composition. The stripping composition may comprise organic functional amine in an amount of less than about 60%, or about 50% by weight of the composition. The composition may comprise benzyl alcohol and organic functional amine together in an amount of at least about 50%, at least about 75%, at least about 85%, or at least 95% by weight of the composition. The composition may comprise benzyl alcohol and organic functional amine together in an amount of less than about 99%, less than about 95%, less than about 85%, less than about 80%, or less than about 75% by weight of the composition.

The composition may comprise solvent in an amount of at least about 50%, at least about 75%, at least about 85%, or at least about 95% by weight of the composition. The composition may comprise solvent in an amount of less than about 99%, less than about 95%, less than about 85%, less than about 80%, or less than about 75% by weight of the composition.

The composition may comprise surfactant in an amount of at least about 20%, at least about 15%, at least about 10%, or at least about 5% by weight of the composition. The composition may comprise surfactant in an amount of less than about 25%, less than about 20%, less than about 15%, or less than about 10% by weight of the composition.

The balance of the composition may be water. For example, the composition may comprise water in an amount of about 0-10%, about 0-5%, or about 3-5% by weight of the composition.

The pH of the composition may be at least about 7, at least about 8, at least about 9, or at least about 10. The pH of the composition may be less than about 14, less than about 13, or less than about 12. This may include a pH of about 7 to about 14, about 8 to about 14, about 9 to about 13, or about 10 to about 12.

The composition may have a viscosity of at least about 1 cP, at least about 5 cP, or at least about 10 cP. The composition may have a viscosity of less than about 80 cP, less than about 75 cP, or less than about 60 cP. This may include a viscosity of about 1 to about 80 cP, about 5 to about 75 cP, or about 10 to about 60 cP.

In some embodiments, the stripping composition may be substantially free of ethylene glycol mono-butyl ether (EGBE). As used herein, “substantially free” means having less than about 3%, less than about 1%, less than about 0.5%, less than about 0.2%, and more particularly about 0.2% to 0% of component. The composition may be substantially free of fluorochemicals. The composition may be substantially free of fatty acids.

Compositions according to the invention may comprise a high concentration of active ingredients, i.e. benzyl alcohol and organic functional amine, yet require substantially no co-solvent. The composition may be substantially free of co-solvent. Compositions according to the invention may be diluted in hard water and still be efficacious and stable. As used herein, hard water may include at least about 200 ppm, at least about 250 ppm, at least about 300 ppm, at least about 350 ppm, or at least about 400 ppm of CaCO₃.

The compositions may also have low foaming properties. Low foam compositions may be analyzed by determining the foam height of the composition, e.g, as described in Example 4 and Example 8. Briefly, a volume of composition is added to a container such as a graduated cylinder. The container is closed, such as with a stopper, before being inverted, for example, ten times. The height of the resulting foam initially (immediately after inversion) as well as at other time points in time after inversion may be compared. As used herein, “low foam” is comparatively lower foam height. For 50 mL of liquid composition placed in a graduated cylinder and inverted ten times, the following classification of foam height may be used, wherein foam height is height of the liquid plus height of the foam in mL:

foam height of 150+mL=high foam

foam height of 100-150 mL=moderate foam

foam height of 75-100 mL=low foam

foam height of 50-75 mL=very low foam

The stripping compositions may be biodegradable. As used herein, “biodegradable” refers to a composition capable of being decomposed by natural processes. Biodegradation may be defined in different ways such as, for example, ready, inherently, and primary biodegradability. Suitable methods for determining biodegradability are known in the art. For example, a standard definition follows Organization for Economic Co-operation and Development (OECD) test methods that determine ready biodegradation. Ready biodegradation, as defined by the OECD, is determined by laboratory tests that measure the degree and the rate of biodegradation over a set time frame (Guidelines for Testing of Chemicals. Ready Biodegradability, Test Guideline 301. Organization for Economic Cooperative and Development, Paris, France 1992). The OECD series of tests include OECD Test Guidelines No. 301 A-F: TG 301 A, TG 301 B, TG 301 C, TG 301 D, TG 301 E, and TG 301 F. A high concentration of a substance is used in each test, and degradation is determined by measuring O₂ consumption, Biochemical Oxygen Demand (BOD), removal of Dissolved Organic Carbon (DOC), CO₂ production, or combinations thereof. The test conditions may vary among each OECD test, but generally the tests measure the feasibility of achieving degradation and the time frame in which ready degradation will be reached. OECD tests for ready biodegradation use 28 days as an end point in the time frame. For example, 80% BOD or COD level may be achieved within 28 days in order for a composition to be considered readily biodegradable. As another example, the OECD defines the following pass levels of biodegradation, obtained within 28 days, for a composition to be regarded as evidence of ready biodegradability: 70% DOC removal (OECD tests TG 301 A and TG 301 E); 60% theoretical carbon dioxide (ThCO₂) (OECD tests TG 301 B); and 60% theoretical oxygen demand (ThOD) (OECD tests TG 301 C, TG 301 D and TG 301 F). A ready biodegradable material may biodegrade rapidly in its environment and, when discharged as wastewater constituents, be effectively degraded during wastewater treatment. However, failure of a material to pass the OECD ready biodegradability criteria may not necessarily mean that the material will not biodegrade in the environment or in the waste stream given sufficient time and circumstances. If composition components individually are biodegradable, it may be inferred that the composition comprising the components is also biodegradable. Compositions comprising at least one of alkyl polyglucosides and TOMADOLS® (suitably, TOMADOL® 91-6, from Air Products and Chemicals, Allentown, Pa.) are particularly suitable for being readily biodegradable.

The stripping compositions may have a favorable aquatic toxicity profile. For example, a composition with a fish LC₅₀ value of 100 mg/L or greater may be considered to have a favorable aquatic toxicity profile. LC₅₀ value is the concentration at which 50% of test organisms survive within a specific exposure period. An aquatic toxicity profile may be determined for a whole formulation. An aquatic toxicity profile for a formulation may also be determined from an additive calculation using acute toxicity data of each component of the formulation. Compositions comprising at least one of alkyl polyglucosides and TOMADOLS® (suitably, TOMADOL® 91-6, from Air Products and Chemicals, Allentown, Pa.) are particularly suitable for having a favorable aquatic toxicity profile.

The components of the compositions according to the invention may be combined and mixed in any order using conventional mixing methods. Examples of conventional mixing methods include, but are not limited to, placing in a container such as a beaker or Erlenmeyer flask with a magnetic stirrer, or mixing in a container with an overhead mixed or lab stirrer (for example, Yamato LR400C from Yamato Scientific American Inc., Santa Clara, Calif.) at about 150 to about 400 rpm, or at about 200 to about 300 rpm. The components may be mixed together until homogenous. The components may be mixed cold, without the addition of heat.

The coating removal compositions may be applied to surfaces, such as coated substrates to be stripped, and the composition may be allowed to contact the coating or the surface or both. Surfaces may include, but are not limited to, floors, counters, walls, or other hard surfaces. The surface may comprise materials including, but not limited to, vinyl, ceramics, marble, terrazzo, linoleum, concrete, rubber, granite, or combinations thereof. Coatings which may be stripped using the stripping compositions of the invention include at least one of paint, resin, epoxy, lacquer, sealant, finish, other coatings and combinations thereof. Examples of coating materials include, but are not limited to, urethane, acrylic, polymer, grease, wax, oil, or combinations thereof. Coatings may include a single layer or multiple layers of the same or different compositions.

The stripping compositions may be applied to at least one of the surface, the coating, and both for a period of contact time (e.g., about 0 to about 10 to about 30 min) before removing the coating. Applying may include any number of techniques including, but not limited to, mopping, pouring, spraying, sprinkling, brushing, immersing, dispensing from a suitable dispenser, etc. Among other things, pads, sponges, three-dimensional non-woven pads, natural or synthetic fiber-based cloths or mops, and other fabrics may be used to apply the stripping compositions or remove the coatings. Additionally, mopping, spraying, abrading, vigorous agitating, applying friction, applying pressure, using automatic scrubbers, vacuuming, flushing with water, etc. may be used to remove the coatings after application of the stripping compositions. The material may be attached to a conventional floor maintenance machine including, but not limited to, swing machines from manufacturers such as TASKI (e.g., TASKI Ergodisc 200 from Diversey, Sturtevant, Wis.), Tennant (Minneapolis, Minn.), and Clarke (Plymouth Minn.), and auto-scrubbers from manufacturers such as TASKI (Diversey, Sturtevant, Wis.), Tennant (Minneapolis, Minn.), Clarke (Plymouth Minn.), and Tomcat (e.g., Tomcat Magnum—26 inch from Tomcat, Racine, Wis.).

The compositions according to the invention may effectively remove at least one coating from a surface when diluted to at least about 1:6, at least about 1:8, at least about 1:10, at least about 1:15, at least about 1:20, at least about 1:30, at least about 1:40, or at least about 1:50, whereas conventional super concentrated strippers are typically diluted much less, for example, to 1:4.

The following examples are intended to further illustrate the invention to those skilled in the art and should not be interpreted as limiting the scope of the invention set forth in the claims.

### EXAMPLES

### Example 1

### Formulation 1

A composition was prepared according to Table 1 (“Formulation 1”).

TABLE 1
Formulation 1.

| Component | % wt |
|---|---|
| benzyl alcohol | 47% |
| Monoethanolamine | 42% |
| TERGITOL ® 15-S-7 | 2% |
| GLUCOPON ® 425N | 6% |
| Water | 3% |
| TOTAL | 100% |

The components were mixed together using a beaker and magnetic stirrer for 2-5 min until homogenous. The pH was 12.00, the free alkalinity was 6.1 meq/g, the total alkalinity was 6.9 meq/g, the viscosity was 20 cps, and the density was 8.69 lbs/gallon.

### Example 2

### Formulation 2

A composition was prepared according to Table 2 (“Formulation 2”).

TABLE 2
Formulation 2.

| Component | % wt |
|---|---|
| benzyl alcohol | 47% |
| Monoethanolamine | 42% |
| NEODOL ™ 91-6 | 2% |
| GLUCOPON ® 425N | 6% |
| Water | 3% |
| TOTAL | 100% |

The components were mixed together using a beaker and magnetic stirrer for 2-5 min until homogenous.

### Example 3

### Stripping Efficiency

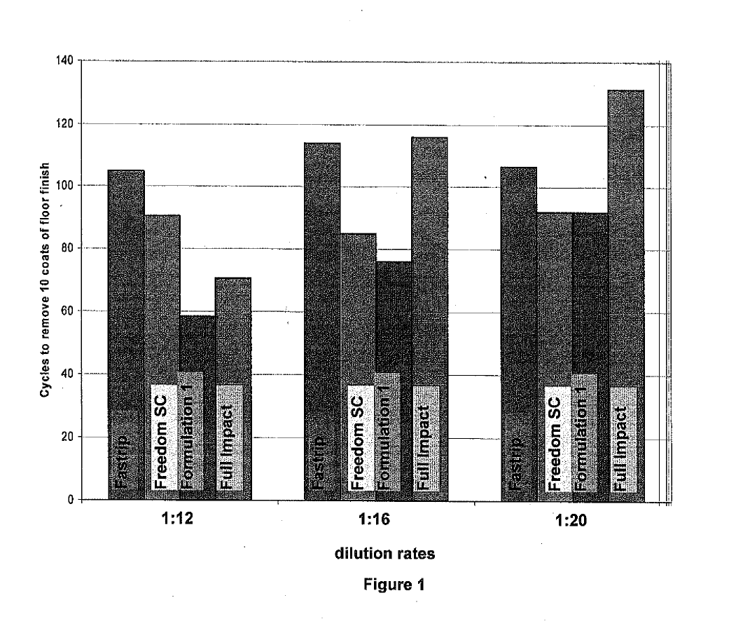

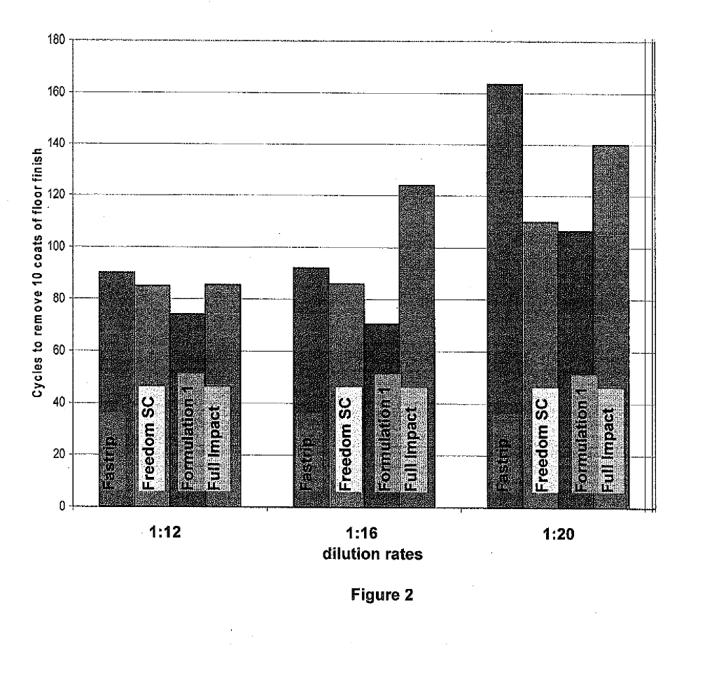

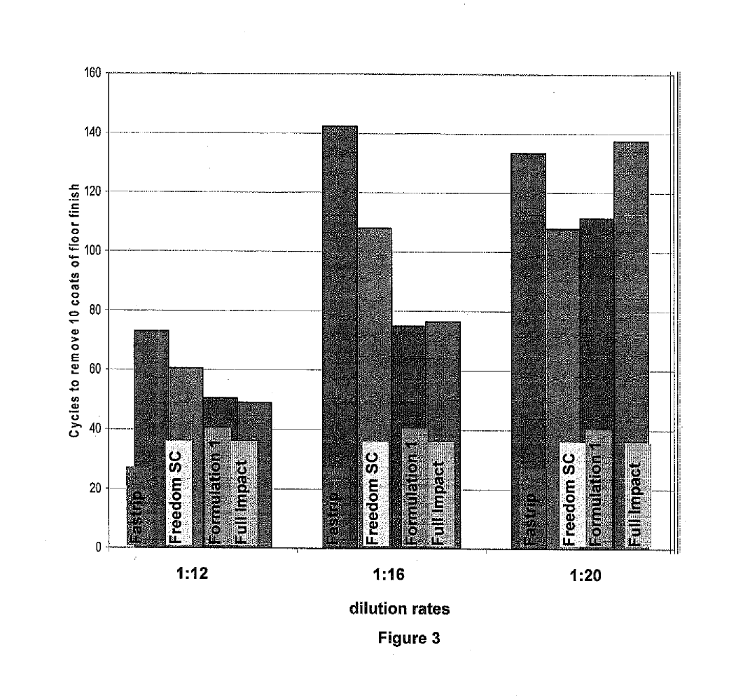

A stripped VCT tile was coated with ten coats of desired floor finish or sealer (SIGNATURE™, VECTRA™, or PREMIA™, from Diversey, Inc., Sturtevant, Wis.). VCT tiles are vinyl composition tiles manufactured by, for example, Tarkett (Nanterre, France), Armstrong (Lancaster, Pa.), and Azrock (Houston, Tex.). Each coat was numbered with a grease pencil, wherein “10” was marked under the 10^{th} coat, “9” was marked under the 9^{th} coat, etc. The tile was then baked in an oven at 120° F. for four days. After baking the tile was cut into 2-inch strips. The tile was placed into Byk-Gardner Scrubber (Byk-Gardner, Columbia, Md.). Formulation 1 (Example 1) was diluted with water to 1:12, 1:16, and 1:20. 30 mL of each dilution was placed on the tile strip. The Byk-Gardner Scrubber, with a red pad attached (3M™ Red Buffer Pad 5100 from 3M, St. Paul, Minn.), was started on the tile. The number of cycles necessary to remove each respective coat was monitored and recorded. Complete removal of a layer was determined once the next layer's number in grease pencil was completely gone. For comparison, the process was repeated for FASTRIP™, FREEDOM® SC, and FULL IMPACT™ stripping compositions (Diversey, Inc., Sturtevant, Wis.). As shown in Tables 3 through 5 and FIGS. 1 through 3, Formulation 1 demonstrated comparable or improved stripping performance on SIGNATURE™, VECTRA™, and PREMIA™ floor finishes, respectively, compared to FASTRIP™, FREEDOM® SC, and FULL IMPACT™ super concentrated stripping compositions.

TABLE 3
Stripping performance on surface coated with SIGNATURE ™ floor finish, indicated in number
of stripping cycles required to remove designated number of coats of finish.
SIGNATURE ™ Stripping Test

| | # of Coats Removed | | | | | | | | | |
|---|---|---|---|---|---|---|---|---|---|---|
| Composition, dilution | 1 | 2 | 3 | 4 | 5 | 6 | 7 | 8 | 9 | 10 |
| FASTRIP ™, 1:12 | 2 | 6 | 7 | 19 | 22 | 34 | 35 | 40 | 60 | 100 |
| FASTRIP ™, 1:12 | 4 | 10 | 11 | 22 | 30 | 45 | 45 | 45 | 59 | 110 |
| FASTRIP ™, 1:12 AVE | 3 | 8 | 9 | 20.5 | 26 | 39.5 | 40 | 42.5 | 59.5 | 105 |
| FASTRIP ™, 1:16 | 15 | 27 | 30 | 40 | 45 | 57 | 74 | 89 | 110 | 125 |
| FASTRIP ™, 1:16 | 10 | 17 | 22 | 34 | 38 | 45 | 56 | 70 | 76 | 103 |
| FASTRIP ™, 1:16 AVE | 12.5 | 22 | 26 | 37 | 41.5 | 51 | 65 | 79.5 | 93 | 114 |
| FASTRIP ™, 1:20 | 10 | 23 | 33 | 39 | 50 | 65 | 77 | 83 | 195 | 103 |
| FASTRIP ™, 1:20 | 17 | 24 | 35 | 38 | 47 | 59 | 69 | 91 | 100 | 110 |
| FASTRIP ™, 1:20 AVE | 13.5 | 23.5 | 34 | 38.5 | 48.5 | 62 | 73 | 87 | 97.5 | 106.5 |
| FREEDOM ® SC, 1:12 | 4 | 10 | 14 | 25 | 30 | 40 | 43 | 45 | 65 | 90 |
| FREEDOM ® SC, 1:12 | 5 | 12 | 15 | 25 | 30 | 30 | 37 | 45 | 55 | 91 |
| FREEDOM ® SC, 1:12 | 4.5 | 11 | 14.5 | 25 | 30 | 35 | 40 | 45 | 60 | 90.5 |
| AVE | | | | | | | | | | |
| FREEDOM ® SC, 1:16 | 9 | 15 | 30 | 35 | 40 | 55 | 57 | 62 | 71 | 85 |
| FREEDOM ® SC, 1:16 | 10 | 14 | 21 | 25 | 27 | 40 | 50 | 54 | 69 | 85 |
| FREEDOM ® SC, 1:16 | 9.5 | 14.5 | 25.5 | 30 | 33.5 | 47.5 | 53.5 | 58 | 70 | 85 |
| AVE | | | | | | | | | | |
| FREEDOM ® SC, 1:20 | 14 | 25 | 30 | 39 | 48 | 54 | 60 | 60 | 80 | 86 |
| FREEDOM ® SC, 1:20 | 14 | 22 | 32 | 37 | 42 | 53 | 68 | 68 | 79 | 98 |
| FREEDOM ® SC, 1:20 | 14 | 23.5 | 31 | 38 | 45 | 53.5 | 64 | 64 | 79.5 | 92 |
| AVE | | | | | | | | | | |
| Formulation 1, 1:12 | 4 | 7 | 16 | 21 | 25 | 28 | 30 | 38 | 47 | 57 |
| Formulation 1, 1:12 | 6 | 8 | 20 | 23 | 27 | 29 | 38 | 44 | 52 | 60 |
| Formulation 1, 1:12 | 5 | 7.5 | 18 | 22 | 26 | 28.5 | 34 | 41 | 49.5 | 58.5 |
| AVE | | | | | | | | | | |
| Formulation 1, 1:16 | 5 | 11 | 14 | 18 | 26 | 31 | 41 | 54 | 62 | 70 |
| Formulation 1, 1:16 | 7 | 13 | 20 | 27 | 39 | 45 | 45 | 63 | 70 | 82 |
| Formulation 1, 1:16 | 6 | 12 | 17 | 22.5 | 32.5 | 38 | 43 | 58.5 | 66 | 76 |
| AVE | | | | | | | | | | |
| Formulation 1, 1:20 | 10 | 20 | 24 | 38 | 45 | 50 | 55 | 65 | 90 | 88 |
| Formulation 1, 1:20 | 15 | 22 | 30 | 39 | 42 | 53 | 65 | 74 | 84 | 96 |
| Formulation 1, 1:20 | 12.5 | 21 | 27 | 38.5 | 43.5 | 51.5 | 60 | 69.5 | 82 | 92 |
| AVE | | | | | | | | | | |
| FULL IMPACT ™, | 10 | 14 | 21 | 30 | 34 | 34 | 42 | 53 | 60 | 72 |
| 1:12 | | | | | | | | | | |
| FULL IMPACT ™, | 10 | 14 | 19 | 28 | 32 | 37 | 48 | 48 | 57 | 69 |
| 1:12 | | | | | | | | | | |
| FULL IMPACT ™, | 10 | 14 | 20 | 29 | 33 | 35.5 | 45 | 50.5 | 58.5 | 70.5 |
| 1:12 AVE | | | | | | | | | | |
| FULL IMPACT ™, | 17 | 27 | 32 | 57 | 68 | 74 | 97 | 106 | 106 | 122 |
| 1:16 | | | | | | | | | | |
| FULL IMPACT ™, | 19 | 23 | 37 | 42 | 49 | 67 | 80 | 90 | 95 | 110 |
| 1:16 | | | | | | | | | | |
| FULL IMPACT ™, | 18 | 25 | 34.5 | 49.5 | 58.5 | 70.5 | 88.5 | 98 | 100.5 | 116 |
| 1:16 AVE | | | | | | | | | | |
| FULL IMPACT ™, | 22 | 30 | 49 | 61 | 68 | 75 | 99 | 104 | 108 | 130 |
| 1:20 | | | | | | | | | | |
| FULL IMPACT ™; | 21 | 27 | 45 | 65 | 65 | 74 | 93 | 100 | 120 | 133 |
| 1:20 | | | | | | | | | | |
| FULL IMPACT ™, | 21.5 | 28.5 | 47 | 63 | 66.5 | 74.5 | 96 | 102 | 114 | 131.5 |
| 1:20 AVE | | | | | | | | | | |

TABLE 4
Stripping performance on surface coated with VECTRA ™ floor finish, indicated in number of
stripping cycles required to remove designated number of coats of finish.
VECTRA ™ Stripping Test

| | # of Coats Removed | | | | | | | | | |
|---|---|---|---|---|---|---|---|---|---|---|
| Composition, dilution | 1 | 2 | 3 | 4 | 5 | 6 | 7 | 8 | 9 | 10 |
| FASTRIP ™, 1:12 | 3 | 7 | 17 | 21 | 29 | 35 | 45 | 55 | 60 | 80 |
| FASTRIP ™, 1:12 | 2 | 4 | 15 | 28 | 38 | 48 | 65 | 75 | 90 | 100 |
| FASTRIP ™, 1:12 AVE | 2.5 | 5.5 | 16 | 24.5 | 33.5 | 41.5 | 55 | 65 | 75 | 90 |
| FASTRIP ™, 1:16 | 3 | 5 | 12 | 20 | 24 | 37 | 45 | 48 | 65 | 80 |
| FASTRIP ™, 1:16 | 2 | 7 | 13 | 21 | 30 | 40 | 54 | 68 | 77 | 104 |
| FASTRIP ™, 1:16 AVE | 2.5 | 6 | 12.5 | 20.5 | 27 | 38.5 | 49.5 | 58 | 71 | 92 |
| FASTRIP ™, 1:20 | 6 | 12 | 21 | 38 | 50 | 65 | 90 | 108 | 128 | 169 |
| FASTRIP ™, 1:20 | 3 | 10 | 20 | 44 | 61 | 72 | 79 | 100 | 130 | 158 |
| FASTRIP ™, 1:20 AVE | 4.5 | 11 | 20.5 | 41 | 55.5 | 68.5 | 84.5 | 104 | 129 | 163.5 |
| FREEDOM ® SC, 1:12 | 3 | 7 | 11 | 17 | 32 | 42 | 55 | 63 | 75 | 91 |
| FREEDOM ® SC, 1:12 | 2 | 5 | 9 | 23 | 32 | 42 | 55 | 58 | 69 | 79 |
| FREEDOM ® SC, 1:12 | 2.5 | 6 | 10 | 20 | 32 | 42 | 55 | 60.5 | 72 | 85 |
| AVE | | | | | | | | | | |
| FREEDOM ® SC, 1:16 | 2 | 6 | 9 | 20 | 25 | 31 | 47 | 57 | 64 | 83 |
| FREEDOM ® SC, 1:16 | 2 | 7 | 15 | 25 | 31 | 41 | 48 | 51 | 68 | 89 |
| FREEDOM ® SC, 1:16 | 2 | 6.5 | 12 | 22.5 | 28 | 36 | 47.5 | 54 | 66 | 86 |
| AVE | | | | | | | | | | |
| FREEDOM ® SC, 1:20 | 3 | 9 | 20 | 29 | 35 | 50 | 63 | 72 | 89 | 115 |
| FREEDOM ® SC, 1:20 | 4 | 10 | 18 | 30 | 40 | 52 | 70 | 76 | 91 | 105 |
| FREEDOM ® SC, 1:20 | 3.5 | 9.5 | 19 | 29.5 | 37.5 | 51 | 66.5 | 74 | 90 | 110 |
| AVE | | | | | | | | | | |
| Formulation 1, 1:12 | 2 | 5 | 11 | 18 | 27 | 32 | 44 | 49 | 58 | 70 |
| Formulation 1, 1:12 | 2 | 6 | 11 | 19 | 29 | 38 | 46 | 51 | 61 | 78 |
| Formulation 1, 1:12 | 2 | 5.5 | 11 | 18.5 | 28 | 35 | 45 | 50 | 59.5 | 74 |
| AVE | | | | | | | | | | |
| Formulation 1, 1:16 | 3 | 7 | 10 | 16 | 19 | 35 | 45 | 47 | 60 | 77 |
| Formulation 1, 1:16 | 3 | 7 | 14 | 23 | 28 | 38 | 41 | 48 | 55 | 64 |
| Formulation 1, 1:16 | 3 | 7 | 12 | 19.5 | 23.5 | 36.5 | 43 | 47.5 | 57.5 | 70.5 |
| AVE | | | | | | | | | | |
| Formulation 1, 1:20 | 3 | 10 | 17 | 34 | 40 | 55 | 68 | 76 | 91 | 111 |
| Formulation 1, 1:20 | 3 | 13 | 19 | 32 | 42 | 50 | 68 | 76 | 95 | 102 |
| Formulation 1, 1:20 | 3 | 11.5 | 18 | 33 | 41 | 52.5 | 68 | 76 | 93 | 106.5 |
| AVE | | | | | | | | | | |
| FULL IMPACT ™, | 3 | 10 | 19 | 28 | 28 | 40 | 55 | 55 | 65 | 84 |
| 1:12 | | | | | | | | | | |
| FULL IMPACT ™, | 2 | 6 | 28 | 28 | 28 | 44 | 55 | 62 | 62 | 87 |
| 1:12 | | | | | | | | | | |
| FULL IMPACT ™, | 2.5 | 8 | 23.5 | 28 | 28 | 42 | 55 | 58.5 | 63.5 | 85.5 |
| 1:12 AVE | | | | | | | | | | |
| FULL IMPACT ™, | 2 | 16 | 33 | 44 | 44 | 73 | 88 | 88 | 101 | 123 |
| 1:16 | | | | | | | | | | |
| FULL IMPACT ™, | 2 | 14 | 33 | 38 | 38 | 61 | 72 | 90 | 107 | 125 |
| 1:16 | | | | | | | | | | |
| FULL IMPACT ™, | 2 | 15 | 33 | 41 | 41 | 67 | 80 | 89 | 104 | 124 |
| 1:16 AVE | | | | | | | | | | |
| FULL IMPACT ™, | 4 | 23 | 47 | 54 | 68 | 87 | 120 | 130 | 136 | 145 |
| 1:20 | | | | | | | | | | |
| FULL IMPACT ™, | 5 | 20 | 41 | 56 | 62 | 78 | 85 | 100 | 120 | 135 |
| 1:20 | | | | | | | | | | |
| FULL IMPACT ™, | 4.5 | 21.5 | 44 | 55 | 65 | 82.5 | 102.5 | 115 | 128 | 140 |
| 1:20 AVE | | | | | | | | | | |

TABLE 5
Stripping performance on surface coated with PREMIA ™ floor finish, indicated in number of
stripping cycles required to remove designated number of coats of finish.
PREMIA ™ Stripping Test

| | # of Coats Removed | | | | | | | | | |
|---|---|---|---|---|---|---|---|---|---|---|
| Composition, dilution | 1 | 2 | 3 | 4 | 5 | 6 | 7 | 8 | 9 | 10 |
| FASTRIP ™, 1:12 | 14 | 20 | 25 | 30 | 36 | 44 | 56 | 64 | 69 | 78 |
| FASTRIP ™, 1:12 | 4 | 11 | 20 | 27 | 33 | 42 | 51 | 54 | 57 | 68 |
| FASTRIP ™, 1:12 AVE | 9 | 15.5 | 22.5 | 28.5 | 34.5 | 43 | 53.5 | 59 | 63 | 73 |
| FASTRIP ™, 1:16 | 6 | 19 | 30 | 44 | 59 | 79 | 94 | 105 | 130 | 162 |
| FASTRIP ™, 1:16 | 4 | 16 | 26 | 42 | 53 | 66 | 80 | 99 | 108 | 123 |
| FASTRIP ™, 1:16 AVE | 5 | 17.5 | 28 | 43 | 56 | 72.5 | 87 | 102 | 119 | 142.5 |
| FASTRIP ™, 1:20 | 6 | 13 | 23 | 33 | 42 | 60 | 71 | 90 | 101 | 128 |
| FASTRIP ™, 1:20 | 7 | 15 | 27 | 38 | 48 | 64 | 72 | 96 | 118 | 139 |
| FASTRIP ™, 1:20 AVE | 6.5 | 14 | 25 | 35.5 | 45 | 62 | 71.5 | 93 | 109.5 | 133.5 |
| FREEDOM ® SC, 1:12 | 7 | 13 | 17 | 22 | 27 | 33 | 45 | 50 | 55 | 60 |
| FREEDOM ® SC, 1:12 | 10 | 15 | 20 | 24 | 28 | 32 | 39 | 44 | 49 | 61 |
| FREEDOM ® SC, 1:12 | 8.5 | 14 | 18.5 | 23 | 27.5 | 32.5 | 42 | 47 | 52 | 60.5 |
| AVE | | | | | | | | | | |
| FREEDOM ® SC, 1:16 | 7 | 20 | 25 | 36 | 45 | 53 | 66 | 76 | 85 | 103 |
| FREEDOM ® SC, 1:16 | 6 | 18 | 28 | 37 | 49 | 62 | 75 | 83 | 95 | 113 |
| FREEDOM ® SC, 1:16 | 6.5 | 19 | 26.5 | 36.5 | 47 | 57.5 | 70.5 | 79.5 | 90 | 108 |
| AVE | | | | | | | | | | |
| FREEDOM ® SC, 1:20 | 6 | 14 | 26 | 35 | 40 | 62 | 68 | 81 | 96 | 115 |
| FREEDOM ® SC, 1:20 | 5 | 12 | 26 | 31 | 35 | 52 | 60 | 73 | 80 | 101 |
| FREEDOM ® SC, 1:20 | 5.5 | 13 | 26 | 33 | 37.5 | 57 | 64 | 77 | 88 | 108 |
| AVE | | | | | | | | | | |
| Formulation 1, 1:12 | 3 | 13 | 19 | 21 | 24 | 25 | 25 | 33 | 33 | 50 |
| Formulation 1, 1:12 | 4 | 13 | 17 | 19 | 28 | 28 | 46 | 47 | 45 | 51 |
| Formulation 1, 1:12 | 3.5 | 13 | 18 | 20 | 26 | 26.5 | 35.5 | 40 | 39 | 50.5 |
| AVE | | | | | | | | | | |
| Formulation 1, 1:16 | 7 | 13 | 22 | 22 | 31 | 40 | 50 | 60 | 75 | 80 |
| Formulation 1, 1:16 | 9 | 9 | 18 | 18 | 33 | 42 | 55 | 55 | 62 | 70 |
| Formulation 1, 1:16 | 8 | 11 | 20 | 20 | 32 | 41 | 52.5 | 57.5 | 68.5 | 75 |
| AVE | | | | | | | | | | |
| Formulation 1, 1:20 | 6 | 17 | 30 | 40 | 48 | 61 | 81 | 88 | 95 | 113 |
| Formulation 1, 1:20 | 8 | 16 | 32 | 37 | 42 | 60 | 67 | 77 | 91 | 110 |
| Formulation 1, 1:20 | 7 | 16.5 | 31 | 38.5 | 45 | 60.5 | 74 | 82.5 | 93 | 111.5 |
| AVE | | | | | | | | | | |
| FULL IMPACT ™, | 3 | 11 | 21 | 21 | 21 | 28 | 37 | 46 | 47 | 51 |
| 1:12 | | | | | | | | | | |
| FULL IMPACT ™, | 2 | 18 | 18 | 30 | 31 | 39 | 39 | 39 | 42 | 47 |
| 1:12 | | | | | | | | | | |
| FULL IMPACT ™, | 2.5 | 14.5 | 19.5 | 25.5 | 26 | 33.5 | 38 | 42.5 | 44.5 | 49 |
| 1:12 AVE | | | | | | | | | | |
| FULL IMPACT ™, | 2 | 20 | 40 | 42 | 45 | 50 | 55 | 55 | 63 | 75 |
| 1:16 | | | | | | | | | | |
| FULL IMPACT ™, | 2 | 13 | 28 | 28 | 35 | 35 | 45 | 45 | 70 | 78 |
| 1:16 | | | | | | | | | | |
| FULL IMPACT ™, | 2 | 16.5 | 34 | 35 | 40 | 42.5 | 50 | 50 | 66.5 | 76.5 |
| 1:16 AVE | | | | | | | | | | |
| FULL IMPACT ™, | 4 | 17 | 50 | 61 | 61 | 77 | 100 | 114 | 131 | 140 |
| 1:20 | | | | | | | | | | |
| FULL IMPACT ™, | 5 | 19 | 41 | 58 | 58 | 77 | 94 | 112 | 115 | 135 |
| 1:20 | | | | | | | | | | |
| FULL IMPACT ™, | 4.5 | 18 | 45.5 | 59.5 | 59.5 | 77 | 97 | 113 | 123 | 137.5 |
| 1:20 AVE | | | | | | | | | | |

### Example 4

### Foam Height

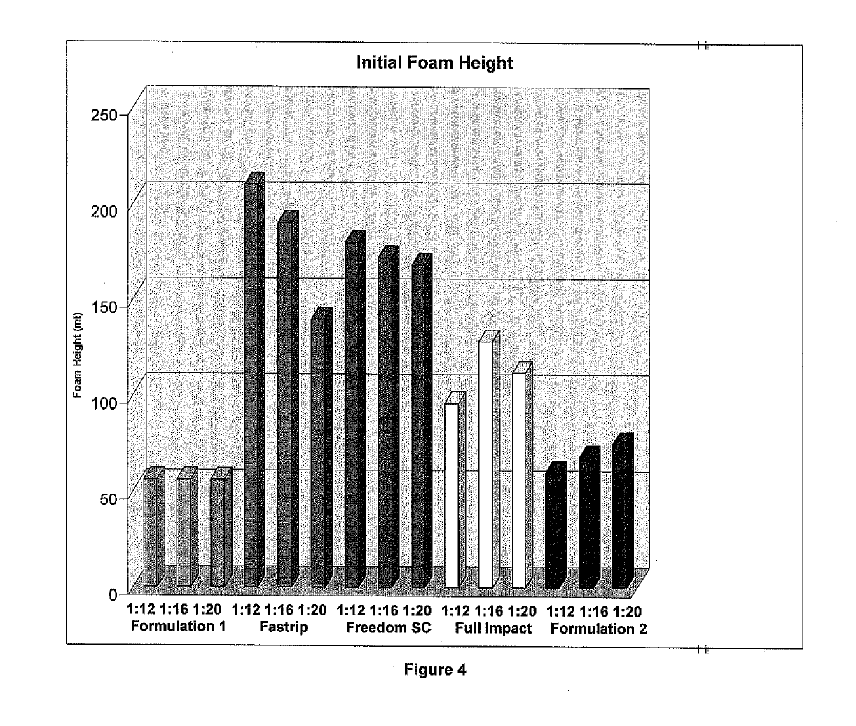

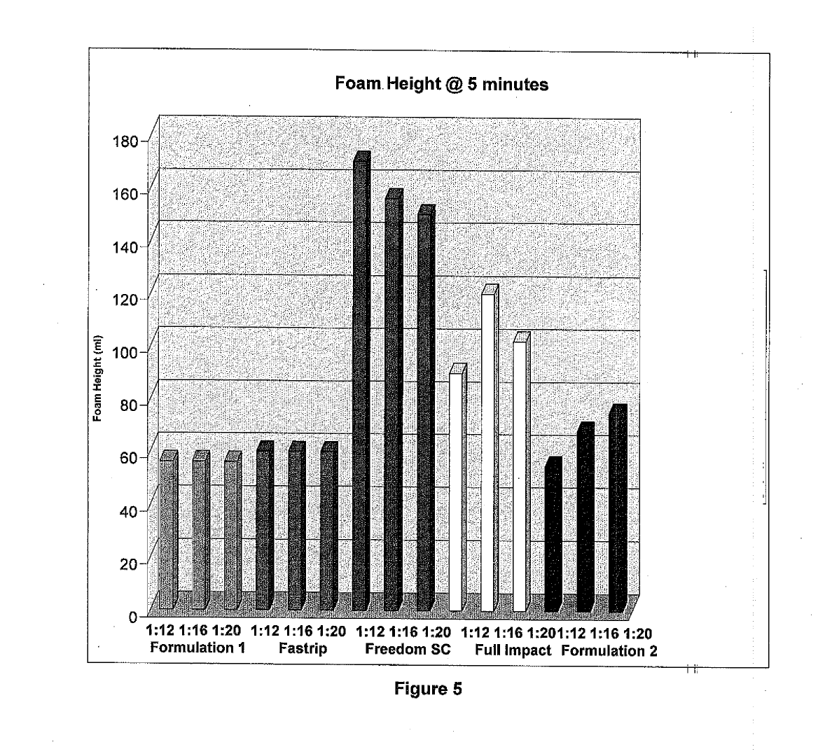

Formulation 1 (Example 1) was diluted to 1:12, 1:16, and 1:20. 50 mL of each dilution was placed into a 250 mL graduated cylinder. A stopper was placed on top of the cylinder, and the cylinder was inverted ten times. The foam height, measured in mL, was the height of the foam and liquid. The initial foam height was recorded, as well as the foam height after 1 min, 2 min, and 5 min of sitting. The process was repeated for Formulation 2 (Example 2) as well as FASTRIP™, FREEDOM® SC, and FULL IMPACT™ stripping compositions for comparison. The humidity for all trials was 50%. As shown in Table 6, Formulations 1 and 2 were low-foaming compared to FASTRIP™, FREEDOM® SC, and FULL IMPACT™ stripping compositions. Comparative foam height initially and at 5 min is shown graphically in FIG. 4 and FIG. 5, respectively.

TABLE 6
Foam Height.

| | |
|---|---|
| Stripping Composition, | Foam Height |

| dilution | Initial | 1 min | 2 min | 5 min |
|---|---|---|---|---|
| Formulation 1, 1:12 | 56 | 56 | 56 | 56 |
| Formulation 1, 1:16 | 56 | 56 | 56 | 56 |
| Formulation 1, 1:20 | 56 | 56 | 56 | 56 |
| Very low foam; almost none at all. | | | | |
| FASTRIP ™, 1:12 | 210 | 142 | 60 | 60 |
| FASTRIP ™, 1:16 | 190 | 136 | 60 | 60 |
| FASTRIP ™, 1:20 | 140 | 108 | 60 | 60 |
| Very high foam initially that rapidly subsided. | | | | |
| FREEDOM ® SC, 1:12 | 180 | 180 | 180 | 170 |
| FREEDOM ® SC, 1:16 | 172 | 172 | 172 | 156 |
| FREEDOM ® SC, 1:20 | 168 | 168 | 168 | 150 |
| Fairly high foam that remained fairly stable. | | | | |
| FULL IMPACT ™, 1:12 | 96 | 96 | 96 | 90 |
| FULL IMPACT ™, 1:16 | 128 | 128 | 128 | 120 |
| FULL IMPACT ™, 1:20 | 112 | 112 | 112 | 102 |
| Fairly low foam that remained fairly stable. | | | | |
| Formulation 2, 1:12 | 60 | 55 | 55 | 55 |
| Formulation 2, 1:16 | 68 | 68 | 68 | 68 |
| Formulation 2, 1:20 | 75 | 75 | 75 | 75 |

Low foam that remained stable.

### Example 5

### Cloud Point Evaluation

Cloud point was determined for the compositions as an indicator of the stability of formation. 200 g of Formulation 1 (Example 1) without dilution was placed into two PETE bottles. One bottle was placed in an oven at 120° F. overnight, and the other bottle was placed in a refrigerator at 40° F. overnight. The composition in the bottles was then observed for cloudiness and phase separation. The bottles were kept at 120° F. and 40° F. for one month, and the composition in the bottles was observed again for cloudiness and phase separation. The process was repeated for Formulation 2 (Example 2). Formulation 1 and Formulation 2 were clear and stable with no sediment present at both the overnight and one-month time points.

### Example 6

### Hard Water Stability

Formulation 1 (Example 1) was diluted to 1:12, 1:16, and 1:20 using 300 ppm hard water. The hard water was prepared by dissolving 1 g of CaCO₃ in 1000 g of deionized water to make a 1000 ppm solution of CaCO₃. Then, 1200 mL of the 1000 ppm solution of CaCO₃ was diluted with 2800 mL of deionized water in a 4000 mL beaker, to yield a 300 ppm solution of CaCO₃. Each dilution was observed for appearance, haze, flocculation, and phase separation. The process was repeated for Formulation 2 (Example 2) as well as FASTRIP™ and FREEDOM® SC stripping compositions for comparison. If no precipitate formed (solution was clear), the solution was classified as stable. A cloudy or hazy appearance was classified as less stable but functional. Results are shown in Table 7.

TABLE 7
Hard Water Stability.

| Stripping Composition, | Appearance at 70° F., |
|---|---|
| dilution | 20% relative humidity |
| Formulation 1, 1:12 | Cloudy appearance, uniform |
| Formulation 1, 1:16 | Cloudy appearance, uniform |
| Formulation 1, 1:20 | Cloudy appearance, uniform |
| FASTRIP ™, 1:12 | Clear |
| FASTRIP ™, 1:16 | Clear |
| FASTRIP ™, 1:20 | Hazy appearance, uniform |
| FREEDOM ® SC, 1:12 | Clear |
| FREEDOM ® SC, 1:16 | Clear |
| FREEDOM ® SC, 1:20 | Clear |
| Formulation 2, 1:12 | Cloudy appearance, uniform |
| Formulation 2, 1:16 | Cloudy appearance, uniform |
| Formulation 2, 1:20 | Cloudy appearance, uniform |

### Example 7

### Floor Finish Removal

Formulation 1 (Example 1) and Formulation 2 (Example 2) were diluted to 1:20 and to 1:15. Each dilution was tested on floors with various floor coatings. A heavy coat was determined to cover about 1000 to about 1500 ft²/gallon, a normal coat was determined to cover about 2000 ft²/gallon, and a thin coat was determined to cover more than about 2500 ft²/gallon.

A 1:20 dilution of Formulation 1 was spread on a floor coated with 4 heavy coats of HIGH MILEAGE™ floor finish (Diversey, Inc., Sturtevant, Wis.). The foam height was low, and the formulation spread evenly on the floor. The floor finish was completely removed in one stripping cycle using a cotton mop and a Byk-Gardner Scrubber with a red pad attached (3M™ Red Buffer Pad 5100 from 3M, St. Paul, Minn.).

A 1:20 dilution of Formulation 1 was spread on a floor coated with 8 normal coats of SIGNATURE™ floor finish (Diversey, Inc., Sturtevant, Wis.). The foam height was low, and the formulation spread evenly on the floor. The floor finish was completely removed in 5 min of dwell time. No rewet was required, i.e., the composition sheeted well and did not dry in 5 min.

A 1:20 dilution of Formulation 1 was spread on a floor coated with 3 coats of FRESH TIMESAVER™ floor finish (Diversey, Inc., Sturtevant, Wis.). The foam height was low, and the formulation spread evenly on the floor. The floor finish was completely removed in one stripping cycle using a cotton mop and a Byk-Gardner Scrubber with a red pad attached (3M™ Red Buffer Pad 5100 from 3M, St. Paul, Minn.).

A 1:20 dilution of Formulation 2 was spread on a floor coated with 8 coats of SIGNATURE™ floor finish (Diversey, Inc., Sturtevant, Wis.). The foam was low, and the formulation spread evenly on the floor. The floor finish was completely removed in one stripping cycle using a cotton mop and a Byk-Gardner Scrubber with a red pad attached (3M™ Red Buffer Pad 5100 from 3M, St. Paul, Minn.).

A 1:15 dilution of Formulation 2 was spread on a floor coated with 8 coats of SIGNATURE™ floor finish (Diversey, Inc., Sturtevant, Wis.). The foam was low, and the formulation spread evenly on the floor. The dilution was viscous during stripping. The floor finish was completely removed in one stripping cycle using a cotton mop and a Byk-Gardner Scrubber with a red pad attached (3M™ Red Buffer Pad 5100 from 3M, St. Paul, Minn.).

### Example 8

### Surfactant Ratio

Compositions 1-24 were prepared and mixed according to Table 8.

TABLE 8
Stripping compositions with varied surfactant ratios.

| | | | surfactants | | | | | | |
|---|---|---|---|---|---|---|---|---|---|
| | | benzyl | | TRITON ™ | | lauryl amine | | NEODOL ™ | |
| | surfactant | alcohol | MEA | BG-10 | LAS-99 | oxide | CS-460 | 91-6 | |
| # | ratio | % wt | % wt | % wt | % wt | % wt | % wt | % wt | dH₂O |
| 1 | 3.3:1 | 37.5 | 50.0 | — | — | 6.67 | — | 2.00 | 3.83 |
| 2 | 1.0:1 | 37.5 | 50.0 | — | 2.06 | — | — | 2.00 | 8.44 |
| 3 | | 37.5 | 50.0 | — | 4.12 | — | — | — | 8.38 |
| 4 | | 37.5 | 50.0 | — | — | 13.33 | — | — | 0.00 |
| 5 | | 37.5 | 50.0 | — | — | — | 6.67 | — | 5.83 |
| 6 | 1.2:1 | 37.5 | 50.0 | 2.86 | — | — | 3.33 | — | 6.31 |
| 7 | 1.7:1 | 37.5 | 50.0 | — | — | — | 3.33 | 2.00 | 7.17 |
| 8 | | 37.5 | 50.0 | 5.71 | — | — | — | — | 6.79 |
| 9 | 2.3:1 | 37.5 | 50.0 | 2.86 | — | 6.67 | — | — | 3.77 |
| 10 | 3.2:1 | 37.5 | 50.0 | — | 2.06 | 6.67 | — | — | 3.77 |
| 11 | 1.4:1 | 37.5 | 50.0 | 2.86 | 2.06 | — | — | — | 7.58 |
| 12 | 1.4:1 | 37.5 | 50.0 | 2.86 | — | — | — | 2.00 | 7.64 |
| 13 | 1.6:1 | 37.5 | 50.0 | — | 2.06 | — | 3.33 | — | 7.10 |
| 14 | 2.0:1 | 37.5 | 50.0 | — | — | 6.67 | 3.33 | — | 2.50 |
| 15 | | 37.5 | 50.0 | — | — | — | — | 4.00 | 8.50 |
| 16 | 1.7:1 | 37.5 | 50.0 | 2.14 | — | — | — | 2.50 | 7.86 |
| 17 | 2.1:1 | 37.5 | 50.0 | 1.43 | — | — | — | 3.00 | 8.07 |
| 18 | 4.9:1 | 37.5 | 50.0 | 0.71 | — | — | — | 3.50 | 8.29 |
| 19 | 2.0:1 | 37.5 | 50.0 | — | — | 5.00 | — | 2.50 | 5.00 |
| 20 | 1.1:1 | 37.5 | 50.0 | — | — | 3.33 | — | 3.00 | 6.17 |
| 21 | 2.1:1 | 37.5 | 50.0 | — | — | 1.67 | — | 3.50 | 7.33 |
| 22 | 1.4:1 | 37.5 | 50.0 | 3.57 | — | 5.00 | — | — | 3.93 |
| 23 | 1.3:1 | 37.5 | 50.0 | 4.29 | — | 3.33 | — | — | 4.88 |
| 24 | 3.0:1 | 37.5 | 50.0 | 5.00 | — | 1.67 | — | — | 5.83 |

*LAS-99 is a linear alkyl benzene sulfonate; CS-460 is lauryl ether sulfate 4EO.

To test foaming, a 50 mL dilution product (1:20 dilution) of each composition was placed into a 250 mL graduated cylinder. A stopper was placed on the top of the cylinder, and the cylinder was inverted 10 times. The foam height, measured in mL, was the height of the foam and liquid. The initial foam height was recorded as well as the foam height after 1 min, 2 min, and 5 min. The rating system was the following:

foam height of 150+mL=high foam

foam height of 100-150 mL=moderate foam

foam height of 0.75-100 mL=low foam

foam height of 50-75 mL=very low foam

To test surface tension, the Wilhelmy plate method was used with a Kruss branded tensiometer and a plate made of platinum. 50-75 mL of diluted (1:20 dilution) product was used to make the measurements. Briefly, the platinum plate was cleaned thoroughly and attached to a scale or balance via a thin metal wire. The force (F) on the plate due to wetting was measured via the Kruss branded tensiometer and used to calculate the surface tension (σ) using the Wilhelmy equation: σ=[F/(2l·cos θ)], wherein l is the wetted length of the Wilhelmy plate and A is the contact angle between the liquid phase and the plate.

To test the wetting properties of the compositions, a 12″×12″ VCT tile was dip coated with 3 coats of TIMESAVER™ Floor finish (Diversey, Inc.) and allowed to cure for 3-5 days. A wire round draw down bar (RDS 10; Webster, N.Y.) was used, which yielded a wet film of liquid approximately 22.86 μm. 1 mL of diluted (1:20 dilution) product was drawn down the tile using the RDS 10 wire round bar. The wetting was rated on a scale of 0 to 6, with 0 being a poor wetting and 6 being outstanding wetting.

The foam height, surface tension, and wetting properties for compositions 1-24 were compared to those for FREEDOM® SC, PRO STRIP™ (Diversey, Sturtevant, Wis.), and water. FREEDOM® SC and PRO STRIP™ were used as positive standards (a rating of 3), and water was used as a negative standard (a rating of 0). Results are shown in Tables 9 and 10.

TABLE 9
Foam height and surface tension results.

| | | Foam | Foam | Foam | Foam | | | |
|---|---|---|---|---|---|---|---|---|
| | surfactant | Height | Height | Height | Height | Surface | Wetting | Wetting |
| # | ratio | (initial) | (1 min) | (2 min) | (5 min) | Tension* | (initial ) | (2 min) |
| 1 | 3.3:1 | 125 | 90 | 70 | 60 | 29.48 | 4 | 4 |
| 2 | 1.0:1 | 130 | 130 | 130 | 130 | 29.88 | 3 | 3 |
| 3 | | 190 | 190 | 190 | 190 | 30.40 | 3 | 3 |
| 4 | | 200 | 200 | 170 | 90 | 29.58 | 0 | 0 |
| 5 | | 190 | 190 | 190 | 180 | 33.69 | 0 | 0 |
| 6 | 1.2:1 | 110 | 110 | 110 | 110 | 31.54 | 2 | 2 |
| 7 | 1.7:1 | 180 | 180 | 150 | 130 | 31.20 | 4 | 4 |
| 8 | | 110 | 110 | 110 | 100 | 27.84 | 4 | 4 |
| 9 | 2.3:1 | 100 | 100 | 90 | 80 | 29.13 | 2 | 3 |
| 10 | 3.2:1 | 220 | 220 | 220 | 200 | 28.25 | 2 | 3 |
| 11 | 1.4:1 | 120 | 120 | 120 | 120 | 29.18 | 2 | 2 |
| 12 | 1.4:1 | 75 | 70 | 70 | 70 | 29.77 | 1 | 1 |
| 13 | 1.6:1 | 130 | 130 | 130 | 130 | 31.79 | 2 | 3 |
| 14 | 2.0:1 | 210 | 210 | 210 | 210 | 29.79 | 2 | 3 |
| 15 | | 90 | 70 | 70 | 60 | 30.62 | 2 | 3 |
| 16 | 1.7:1 | 79 | 79 | 79 | 74 | 30.17 | 4 | 3 |
| 17 | 2.1:1 | 95 | 70 | 60 | 58 | 30.20 | 3 | 3 |
| 18 | 4.9:1 | 90 | 90 | 90 | 70 | 30.28 | 4 | 3 |
| 19 | 2.0:1 | 140 | 140 | 140 | 110 | 29.58 | 3 | 3 |
| 20 | 1.1:1 | 130 | 72 | 72 | 56 | 29.64 | 4 | 4 |
| 21 | 2.1:1 | 120 | 70 | 70 | 66 | 29.94 | 4 | 4 |
| 22 | 1.4:1 | 90 | 76 | 76 | 70 | 28.99 | 4 | 3 |
| 23 | 1.3:1 | 168 | 160 | 160 | 160 | 28.82 | 4 | 4 |
| 24 | 3.0:1 | 130 | 130 | 130 | 130 | 28.52 | 4 | 3 |
| water | | — | — | — | — | 72.90 | 0 | 0 |
| FREEDOM ® | | 140 | 110 | 55 | 55 | 23.26 | 2 | 3 |
| SC | | | | | | | | |
| PRO | | 230 | 120 | 100 | 75 | 30.81 | 3 | 3 |
| STRIP ™ | | | | | | | | |

*Surface tension ran at recommended dilutions (i.e., Prototypes at 1:20, PRO STRIP ™ at 1:4, FREEDOM ® SC at 1:15)

TABLE 10
Wetting results.

| | surfactant | Foam | Foam | Wetting | |
|---|---|---|---|---|---|
| # | ratio | (bucket) | (on floor) | (initial) | Dry out |
| 1 | 3.3:1 | 2 | 2 | 1 | 2 |
| 16 | 1.7:1 | 2 | 2 | 2 | 3 |
| 17 | 2.1:1 | 2 | 1 | 3 | 5 |
| 18 | 4.9:1 | 2 | 2 | 2 | 4 |
| 20 | 1.1:1 | 1 | 3 | 3 | 5 |
| 21 | 2.1:1 | 3 | 3 | 3 | 4 |
| 22 | 1.4:1 | 0 | 1 | 2 | 4 |
| FREEDOM ® | | 3 | 3 | 3 | 3 |
| SC | | | | | |

Thus, the invention provides, among other things, a composition for stripping a coating from a surface. Various features and advantages of the invention are set forth in the following claims.

1. A composition suitable for stripping coatings from a surface, the composition comprising:
a) a solvent; and
b) an organic functional amine, wherein the composition comprises solvent and the organic functional amine together in an amount of at least about 75% by weight of the composition.

2. The composition of claim 1, wherein the solvent is in an amount of about 25 to about 50% by weight of the composition.

3. The composition of claim 1, wherein the solvent comprises at least one of benzyl alcohol, diethylene glycol butyl ether, ethylene glycol butyl ether, ethylene glycol phenyl ether, and propylene glycol phenyl ether.

4. The composition of claim 3, wherein the solvent comprises benzyl alcohol.

5. (canceled)

6. The composition of claim 1, wherein the organic functional amine comprises at least one of monoethanolamine, diethanolamine, triethanolamine, monoisopropanolamine, and a combination thereof.

7. The composition of claim 1, wherein the composition further comprises at least two surfactants selected from the group consisting of anionic, nonionic, and amphoteric surfactants.

8. (canceled)

9. The composition of claim 7, wherein the at least one surfactant comprises at least a primary alcohol ethoxylate, a secondary alcohol ethoxylate, an alkyl polyglucoside, an alkyl diphenyloxide disulfonates, amine oxides, or a combination thereof.

10. The composition of claim 7, wherein the at least two surfactants are present in a ratio of about 1:6 to about 6:1.

11. (canceled)

12. The composition of claim 1, wherein the composition is biodegradable.

13. The composition of claim 12, wherein the composition passes at least one of the OECD TG 301 A and TG 301 E tests.

14. The composition of claim 12, wherein the composition passes at least one of the OECD TG 301 B, TG 301 C, TG 301 D, and TG 301 F tests.

15. The composition of claim 1, wherein the composition has a fish LC₅₀ value of at least 100 mg/L.

16. The composition of claim 1, wherein the composition is substantially free of fluorochemicals and substantially free of fatty acids.

17. The composition of claim 1, wherein the composition is very low foam to moderate foam.

18. A method of stripping a coating at least partially on a surface, the method comprising applying the composition of claim 1 to the coating.

19. A composition suitable for stripping coatings from a surface, the composition comprising:
a) benzyl alcohol in an amount of about 25 to about 50% by weight of the composition; and
b) an organic functional amine in an amount of about 25 to about 50% by weight of the composition, wherein the composition is substantially free of fatty acid.

20. The composition of claim 19, wherein the organic functional amine comprises at least one of monoethanolamine, diethanolamine, triethanolamine, monoisopropanolamine, and a combination thereof.

21. The composition of claim 19, wherein the composition further comprises at least one surfactant selected from the group consisting of anionic and nonionic surfactants.

22. (canceled)

23. The composition of claim 21, wherein the at least one surfactant is selected from the group consisting of primary alcohol ethoxylates, secondary alcohol ethoxylates, alkyl polyglucosides, amine oxides, and alkyl diphenyloxide disulfonates.

24. The composition of claim 21, wherein the composition comprises at least two surfactants present in a ratio of about 1:6 to about 6:1.

25. (canceled)

26. The composition of claim 19, wherein the composition is substantially free of fluorochemicals and fatty acids.

27. The composition of claim 19, wherein the composition is biodegradable.

28. The composition of claim 27, wherein the composition passes at least one of the OECD TG 301 A and TG 301 E tests.

29. The composition of claim 27, wherein the composition passes at least one of the OECD TG 301 B, TG 301 C, TG 301 D, and TG 301 F tests.

30. The composition of claim 19, wherein the composition has a fish LC₅₀ value of at least 100 mg/L.

31. The composition of claim 19, wherein the composition is very low foam to moderate foam.

32. A method of stripping a coating from a surface, the method comprising applying the composition of claim 19 to the coating.

33. A composition suitable for stripping coatings from a surface, the composition comprising:
a) benzyl alcohol;
b) an organic functional amine; and
c) at least two surfactants, wherein the surfactants are present in a ratio of about 1:6 to about 6:1.

34. (canceled)

35. The composition of claim 33, wherein the organic functional amine is selected from the group consisting of monoethanolamine, diethanolamine, monoisopropanolamine, and triethanolamine.

36. The composition of claim 33, wherein at least one surfactant is selected from the group consisting of anionic and nonionic surfactants.

37. The composition of claim 33, wherein at least one surfactant is selected from the group consisting of primary alcohol ethoxylates, secondary alcohol ethoxylates, alkyl polyglucosides, amine oxides, and alkyl diphenyloxide disulfonates.

38. The composition of claim 33, wherein the composition is substantially free of fluorochemicals and fatty acids.

39. The composition of claim 33, wherein the composition is biodegradable.

40. The composition of claim 39, wherein the composition passes at least one of the OECD TG 301 A and TG 301 E tests.

41. The composition of claim 39, wherein the composition passes at least one of the OECD TG 301 B, TG 301 C, TG 301 D, and TG 301 F tests.

42. The composition of claim 33, wherein the composition has a fish LC₅₀ value of at least 100 mg/L.

43. The composition of claim 33, wherein the composition is very low foam to moderate foam.

44. A method of stripping a coating from a surface, the method comprising applying the composition of claim 33 to the coating.
